(19) United States
(12) Patent Application Publication
(10) Pub. No.: US 2023/0109859 A1
(43) Pub. Date: Apr. 13, 2023

(54) AUGMENTED SYNTHETIC EXTENSION CAPABILITY

(71) Applicant: Booz Allen Hamilton Inc., McLean, VA (US)

(72) Inventors: RITCH CHAD, McLean, VA (US); Lynwood Rabon, McLean, VA (US); Jon Purgason, McLean, VA (US); James B. Hartman, McLean, VA (US)

(73) Assignee: Booz Allen Hamilton Inc., McLean, VA (US)

(21) Appl. No.: 17/993,460

(22) Filed: Nov. 23, 2022

Related U.S. Application Data
(60) Provisional application No. 62/283,805, filed on Sep. 14, 2015.

(51) Int. Cl. F41G 3/26; G09B 9/00

(52) U.S. Cl. CPC F41G 3/26; G09B 9/003

(57) ABSTRACT

Synthetic training interface devices, methods, and systems. A synthetic training device includes a processor, a communications interface in communication with the processor, a measurement device in communication with the processor, and an input device disposed on a live training device and configured to receive input from a user. Calibration information is captured. The calibration information includes orientation, position, inertial, and/or geometric information regarding the synthetic training interface device, a live training device coupled to the synthetic training interface device, the user, and/or a synthetic training environment. The calibration information is captured via a measurement device and/or user input.

### CROSS REFERENCE TO RELATED APPLICATIONS

This claims the benefit of U.S. Provisional Application No. 62/283,805, filed Nov. 29, 2021, the content of which is hereby incorporated by reference herein.

### BACKGROUND

Modern industries increasingly incorporate computer graphics, augmented reality, and other simulations into user training. Such training is sometimes referred to as simulated training. In some cases, simulated training has the advantage of reduced cost and increased safety as compared with live training.

In order to improve the quality of simulated training, in some cases, aspects of live training are combined with simulated training. Such combined training is sometimes referred to as synthetic training.

### BRIEF DESCRIPTION OF THE DRAWINGS

FIG. 1 is a block diagram of an example device in which one or more features of the disclosure can be implemented;

FIG. 2 is a block diagram illustrating an example synthetic training interface device;

FIG. 3 is an illustration of an example synthetic training environment including the interface device described with respect to FIG. 2;

FIG. 4 is a flow chart illustrating example calibration of the interface device described with respect to FIGS. 2 and 3;

FIG. 5 is a flow chart illustrating example operation of the interface device described with respect to FIGS. 2, 3, and 4; and

FIG. 6 is a flow chart illustrating another example operation of the interface device described with respect to FIGS. 2, 3, and 4.

### DETAILED DESCRIPTION

Previous synthetic training systems require a simulated replica to be designed or purchased for each and every device that is desired to add to the simulation. In order to avoid this cost and inconvenience of this, an interface is described which attaches to a piece of real-world equipment, and translates it into the simulation.

Examples of real-world items include levers or controls on large machinery, steering or other controls on vehicles or vessels, and civilian or military weapons. The interface can provide wireless data indicating direction, pitch, yaw, button clicks and a host of other programmable features that a simulation may require. The interface can be calibrated to provide a more accurate representation of the live training device in the simulation. The interface can provide a wireless video input to receive video from the simulation if desired. The interface can be “wrapped” in different skins to simulate equipment or can simply attach to existing controls. This can enable any real-world piece of equipment, such as a weapon, ranging device, designation device, illumination device, or vehicle, to be turned into a simulation or video game controller. The interface can eliminate the need for specialized simulation devices and increase interactive game opportunities.

To provide suitable realism and training quality in synthetic training, in some cases, it is advantageous to provide simulation interfaces which duplicate or approximate equipment or other objects which would ordinarily be used in live training. Accordingly, in some implementations, an interface is provided which attaches or integrates with a real-world object which is used as a live training device, and allows a user to interact with a simulation using the live training device. In some implementations the interface includes a calibration capability whereby geometric, functional, positional, orientational, acceleration, inertial, and/or other properties of the live training device or object, input device, and/or a user operator are captured and applied to the simulation, e.g., in order to more accurately represent the live training device and/or user in the simulation.

Some implementations provide a virtual environment extension tool that facilitates incorporation of real world objects, such as “organic” weapon systems, into virtual simulations. This can have the advantage of allowing training at the point-of-need to help train, sustain, and assess unit live-fire prerequisites. Some implementations provide a system that is modular, mobile, and/or attachable, ready at the point-of-need, combines virtual and live training, increases user preparedness, mitigates risk, and overcomes training area limitations.

Some implementations facilitate mounting an output device, such as a screen, on weapons or other equipment, to allow soldiers or other users to discriminate threats and prioritize for the order of engagements in a 360° Virtual Environment using kinesthetic learning. Some implementations facilitate transitioning virtual training from a flat monitor to a physical piece of equipment. Some implementations facilitate an augmented VR solution which increases capabilities associated with target/threat identification, weapon proficiencies, and/or crew drills to provide a 360-degree experience during engagement.

Some implementations provide a low-cost solution to an existing program of record. Some implementations have a total set-up time of a training device that is less than five minutes. In some implementations, the training device can attach to any crew served weapon or other equipment, making it tailorable to provide unique training needs, future range, and/or certifications for a user.

Some implementations have the advantage of facilitating preparation for live training. For example, some implementations provide enhanced synthetic training with an organic system prior to live training. Some implementations facilitate the use of organic and simulated equipment inside live, virtual, constructive, and gaming tools (LVC-G) with the same form, fit, function, or use of the actual equipment. MASC combines the tactile experience of organic systems with robust training scenarios in virtual environments to reinforce the psychomotor and cognitive aspects of training.

Some implementations have the advantage of enabling greater flexibility to support training needs. For example, some implementations provide greater flexibility to train at the point-of-need and conduct sustainment or skills assessment. Some implementations facilitate increased realism required for target/threat identification and engagement, weapon proficiencies, and user drills. Some implementations provide a 360-degree virtual experience while simultaneously engaging with a surrogate or organic system that provides proficiency of the live equipment. Some implementations help to overcome environmental restrictions on individual or collective training events, such as frequency management and airspace coordination.

Some implementations have the advantage of integrating with existing systems. For example, some implementations are simulation or game engine agnostic, which may have the advantage of reducing development time and promoting ease of integration with existing systems. For example, following the Army's modular open systems approach (MOSA) to development, some implementations can be rapidly prototyped or versioned for new equipment models. In some implementations, e.g., combined with the extended reality analytics engine (XRAE), some implementations provide the advantage of enabling users to achieve the lifecycle of training from performance to evaluation.

Some implementations provide costs savings. For example, in some implementations, synthetic training with a low-cost, accessible surrogate or with organic equipment widens the training footprint, allowing users more active time in training scenarios while using fewer resources, such as expendables, equipment, or travel time/coordination. Some implementations can be set up in a matter of minutes and are tailorable to an organization's training needs. In some implementations, integration in virtual or augmented environments ensures a wholistic, efficient, effective, and cost-effective approach to training.

Some implementations provide a synthetic training system. The system includes a processing device, and a memory device. The system also includes an input interface configured to receive user input based on user actuation of a live training object and to transmit the user input to the processing device. The system also includes a measurement device physically coupled to the live training object and configured to measure physical information of the live training object and to transmit the physical information to the processing device. The processing device is configured to capture calibration information via the measurement device or the input interface and to store the calibration information in the memory device or to transmit the calibration information to a simulation server. The system also includes a communications interface configured to transmit user information to the simulation server and to receive simulation information from the simulation server, the user information based on the user input, based on the physical information, and based on the calibration information, and the simulation information based on the user input, based on the physical information, and based on the calibration information. The system also includes an output device configured to present a simulation to the user, wherein the simulation is based on the simulation information.

In some implementations, the processing device is configured to modify the user input based on the calibration information. In some implementations, the input interface comprises a button, pressure sensor, angle sensor, or switch. In some implementations, the measurement device comprises a position sensor, level sensor, or accelerometer. In some implementations, the live training object comprises a piece of equipment or a surrogate for the piece of equipment. In some implementations, the live training object comprises a infrared zoom laser illuminator designator (IZLID), laser rangefinder, or lightweight laser designator rangefinder (LLDR). In some implementations, the calibration information comprises orientation, position, inertial, and/or geometric information regarding the live training object, the user, and/or a training environment. In some implementations, the communications interface comprises a universal serial bus (USB), Bluetooth connection, or WiFi connection. In some implementations, the output device comprises a display, projector, haptic inter-face, and/or virtual reality headset. In some implementations, the simulation comprises a virtual battlespace simulation (VBS).

Some implementations provide a method for synthetic training of a user. User input based on user actuation of a live training object is received. The user input is transmitted to a processing device. Physical information of the live training object is measured. The physical information is transmitted to the processing device. Calibration information is captured and stored in a memory device or transmitted to a simulation server via a communications interface. User information is transmitted to the simulation server, and simulation information is received from the simulation server. The user information is based on the user input, based on the physical information, and based on the calibration information. The simulation information is based on the user input, based on the physical information, and based on the calibration information. A simulation is presented to the user. The simulation is based on the simulation information.

In some implementations, the user input is modified based on the calibration information. In some implementations, the user input is received via a input interface which comprises a button, pressure sensor, angle sensor, or switch. In some implementations, the physical information is received via a measurement device that is physically coupled to the live training object and which comprises a position sensor, level sensor, or accelerometer. In some implementations, the live training object comprises a piece of equipment or a surrogate for the piece of equipment. In some implementations, the live training object comprises an infrared zoom laser illuminator designator (IZLID), laser rangefinder, or lightweight laser designator rangefinder (LLDR). In some implementations, the calibration information comprises orientation, position, inertial, and/or geometric information regarding the live training object, the user, and/or a training environment. In some implementations, the user input is transmitted to the simulation server via the communications interface, and the simulation information is received via the communications interface, wherein the communications interface comprises a universal serial bus (USB), Bluetooth connection, or WiFi connection. In some implementations, the simulation is presented to the user on an output device which comprises a display, projector, haptic interface, and/or virtual reality headset. In some implementations, the simulation comprises a virtual battlespace simulation (VBS).

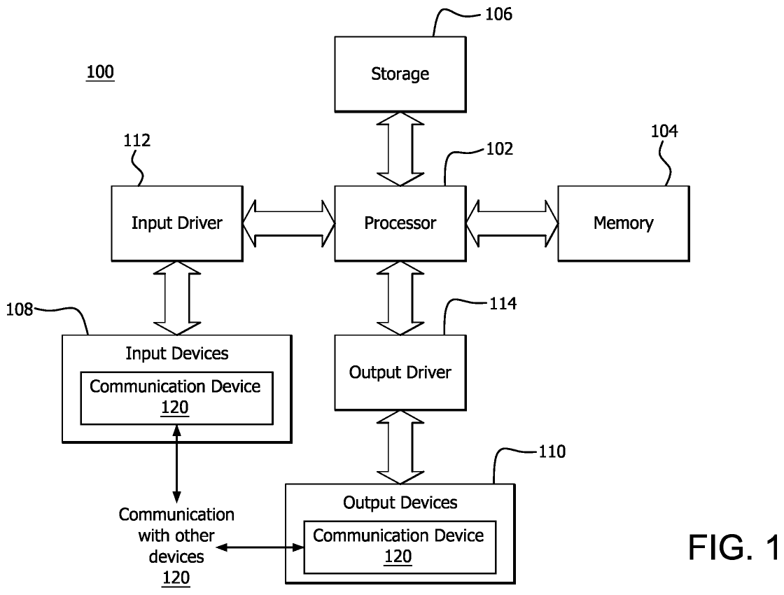

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 108 (e.g., controlling operation, receiving inputs from, and providing data to input drivers 112). Similarly, any of the output drivers 114 are embodied as hardware, a combination of hardware and software, or software, and serve the purpose of controlling output devices (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110.

A communication device 120 includes both input devices 108, such as a wired or wireless receiver, and output devices, such as a wired or wireless transmitter, for communicating with one or more other electronic devices. Examples of such communications devices include wired local area network (“LAN”) devices, wireless LAN devices, cellular devices, or other communication devices.

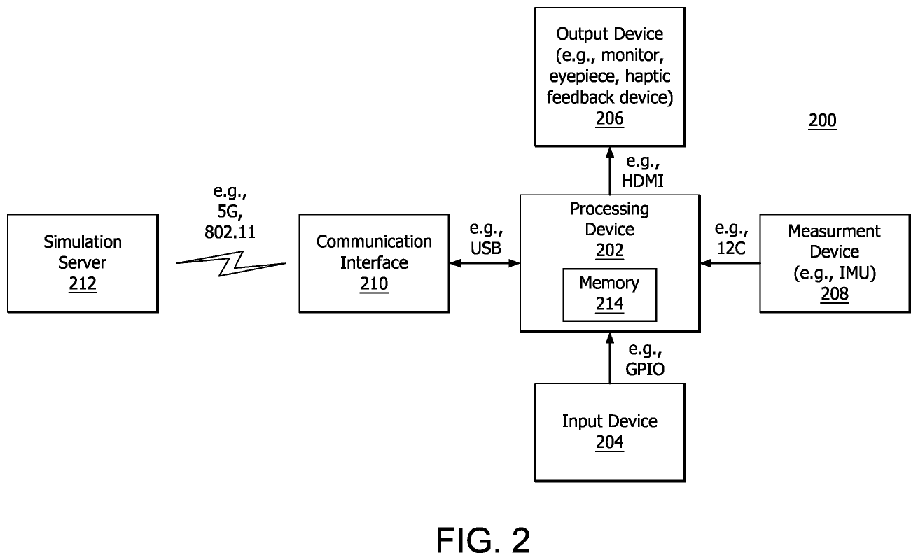

FIG. 2 is a block diagram illustrating an example synthetic training interface device 200. Device 200 includes a processing device 202, input device 204, output device 206, measurement device 208, and a communications interface 210. Device 200 is in communication with a simulation server 212 via the communications interface 210. In some implementations, device 200 includes device 100 as shown and described with respect to FIG. 1, or aspects thereof.

Processing device 202 includes any suitable hardware and/or software for displaying a simulation and receiving input from a user. For example, in some implementations, processing device 202 includes a central processing unit (CPU) and/or a graphics processing unit (GPU). In some implementations, processing device 202 includes a personal computer, smart phone, and/or programmable microcontroller, such as an Arduino™ or Raspberry Pi™ device. Processing device 202 also includes a memory 214, however it is noted that, as with other aspects of interface device 200, memory 214 may be in communication with but outside of processing device 202 instead.

In some implementations, processing device 202 includes processor 102 as shown and described with respect to FIG. 1, or aspects thereof. In some implementations, processing device 202 includes further elements as shown and described with respect to FIG. 1, such as memory 104, storage 106, input driver 112, output driver 114, input devices 108, and/or output devices 110.

In some implementations, memory 214 stores configuration information for input device 204 and/or other aspects of device 200. In some implementations, memory 214 includes a device such as memory 104 and/or storage 106 as shown and described with respect to FIG. 1. In some implementations, the configuration information includes information describing geometric, functional, and/or other properties of a live training device or object as further described herein.

Input device 204 includes and/or is disposed on, attached to, and/or integrated with any device suitable for applying to a live training device or object and accepting user input based on user actuation of the live training device or object. For example, in some implementations, input device 204 includes a pressure sensor disposed on a trigger of a weapon, a position sensor disposed on an operating lever of a construction vehicle, or a voltage sensor in communication with an activation button of a laser designator. Input device 204 provides information indicating the user input to processing device 202 via any suitable wired or wireless communications interface and/or medium, such as a General Purpose Input/Output (GPIO) interface. In some implementations, input device 204 includes at least one of input devices 108 as shown and described with respect to FIG. 1, or aspects thereof.

In some implementations, configuration information regarding input device 204, such as geometric, functional, positional, orientational, acceleration, inertial, and/or other properties of the live training device or object, input device 204, and/or a user operator, are stored in memory 214, on simulation server 212, or in any other suitable memory and/or storage location in communication with device 200. In some implementations, the configuration information is entered by a user via keyboard or any other suitable interface, is loaded from a configuration file from any suitable source, and/or is captured by measurement device 208, e.g., during manipulation or movement of input device 204 and/or a live training device or object attached to input device 204, and/or a user operating the live training device or object and/or input device 204.

Output device 206 includes any suitable device for providing simulation information to a user. For example, in some implementations, output device 206 includes a monitor or other display, virtual reality headset, video projector, audio speaker, haptic feedback device, or any other suitable device for providing information to the user. In some implementations, output device 206 includes at least one of output devices 110 as shown and described with respect to FIG. 1, or aspects thereof.

Output device 206 receives simulation information for output to the user from processing device 202 via any suitable wired or wireless communications interface and/or medium. For example, in some implementations, such as a High Definition Multimedia Interface™ (HDMI).

Measurement device 208 includes any suitable device for capturing position and/or orientation and/or other information of the user or a training device. For example, in some implementations measurement device 208 includes an accelerometer, inertial measurement unit (IMU), mapping position sensor (MPU), and/or global positioning system (GPS) sensor, and captures geometric, functional, positional, orientational, acceleration, inertial, and/or other suitable properties and/or measurements. Measurement device 208 can be considered an input device, in some implementations, however it is described separately from input device 204 herein for clarity and ease of description. In some implementations, measurement device 208 is disposed on, attached to, or integrated with the live training device.

Measurement device 208 provides information indicating position and/or orientation of the user and/or training device to processing device 202 via any suitable wired or wireless communications interface and/or medium, such as an Inter-Integrated Circuit™ (I2C) interface. In some implementations, measurement device 208 includes at least one of input devices 108 as shown and described with respect to FIG. 1, or aspects thereof.

In some implementations, geometric, functional, positional, orientational, acceleration, inertial, and/or other suitable properties and/or measurements of the user and/or training device captured by measurement device 208 transmitted to simulation server 212 and/or stored in memory 214, e.g., as configuration information and/or as part of a configuration operation.

Communications interface 210 includes any suitable device for communications between processing device 202 and simulation server 212. Communications interface 210 communicates with simulation server 212 via any suitable wired or wireless communications interface and/or medium. For example, in some implementations, such as a Universal Serial Bus™ (USB). For example, in some implementations, communications interface 210 includes a wireless network transceiver, such as a dual-band WiFi transceiver, or a wired interface, such as a USB receiver and transmitter. Communications interface 210 can be considered an input and/or output device, in some implementations, however it is described separately herein for clarity and ease of description.

Communications interface 210 receives information for output to the user from simulation server 212, and provides this information to processing device 202. Communications interface 210 also receives user and/or training device input and/or position and/or orientation information from processing device 202 and transmits this information to simulation server 212.

Communications interface 210 communicates with processing device 202 via any suitable wired or wireless communications interface and/or medium. For example, in some implementations, such as a Universal Serial Bus™ (USB). Communications interface 210 communicates with simulation server 212 via any suitable wired or wireless communications interface and/or medium. For example, in some implementations, such as a 3GPP Fifth Generation™ (5G) cellular or IEEE 802.11 (WiFi™) network. In some implementations, communications interface 210 includes a communication device 120 as shown and described with respect to FIG. 1, or aspects thereof.

Simulation server 212 includes a computer server, laptop, cloud computing system, or any other suitable hardware and/or software configured to run a training simulation program and provide a simulated and/or synthetic training environment to a user, e.g., via a user interface device such as device 200. In some implementations, a representation of the live training device or object and/or user, and/or information regarding the live training device or object and/or user, are provided to and/or incorporated into the simulated and/or synthetic training environment based on, e.g., the configuration information.

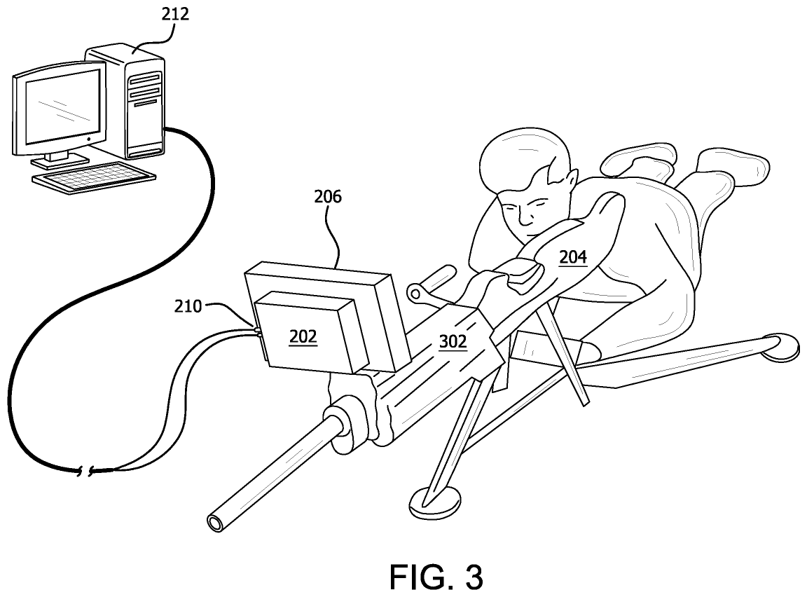

FIG. 3 is an illustration of an example synthetic training environment 300, including interface device 200 described with respect to FIG. 2, and a live training device 302.

Live training device 302 includes a device or object which a user would use in a scenario for which the synthetic training environment is configured to provide training to the user, or a portion or model thereof. In this example, live training device 302 is illustrated as a M249 light machine gun, however, it is noted that any suitable live training device is usable in other implementations, and is not limited to a weapon. For example, in some implementations, a live training device includes a construction vehicle, such as a dump truck, a portion thereof, or a model thereof, or sports equipment, such as a golf club or baseball bat, a portion thereof, or a model thereof.

Various aspects of interface device 200 are shown with respect to live training device 302. For example, processing device 202 is shown mounted to live training device 302. Other aspects of interface device 200 are not shown in FIG. 3. In this example, measurement device 208 is not shown, and is considered to be integrated into processing device 202. It is noted that the various aspects of interface device 200 are combinable or separable in other implementations where suitable, as desired.

Input device 204 is shown mounted to training device 302 in a position to be actuated by the user. In this example, input device 204 is a pressure sensor mounted to a trigger to provide simulated actuation of training device 302, however input device 204 provides any suitable input from the user in other implementations.

Output device 206 is shown mounted to training device 302 in a position visible to the user. In this example, output device 206 is disposed in a position relative to the user to provide a simulated field of fire, however output device 206 provides any suitable output to the user in other implementations.

Communications interface 210 is shown mounted to processing device 202. Communications interface 210 is shown as a wired interface to simulation server 212 in this example, however communications interface 210 includes any suitable wired and/or wired communications interface in other implementations.

Simulation server 212 is configured to provide a simulation for a synthetic training environment which includes the user and live training device 302. In this example, simulation server 212 provides a simulated field of fire for display to the user on output device 206, and receives information from the user via actuation of input device 204 and/or movement of the live training device 302 as captured by the measurement device 208 (not shown). It is noted that this is only an example synthetic training environment. Other example implementations include heavy machinery operation training and/or sports training environments and equipment.

In some implementations, the information received from the user via actuation of input device 204 and/or movement of the live training device 302 is interpreted by the simulation server based on the configuration information. For example, in some implementations, a position and/or rate of movement of the user is inferred based on dimensions of the user and/or live training device 302. In this example, the simulation server 212 displays targets to the user and scores hits and misses based on movement and actuation of the live training device 302 by the user, as captured by input device 204 and/or measurement device 208 (not shown).

It is noted that any other suitable simulation is provided in other implementations. For example, in some implementations, simulation server 212 is configured to provide a view of a simulated construction site to a user, and to record user performance metrics based on movement and actuation of a different live training device 302, such as a vehicle cockpit including steering and actuation controls.

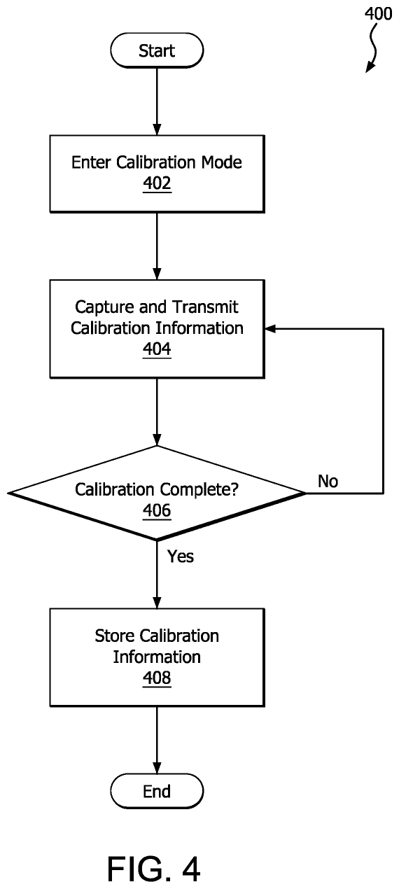

FIG. 4 is a flow chart illustrating example calibration of interface device 200 described with respect to FIGS. 2 and 3. In some implementations, the calibration mode captures information describing the input device 204, live training device 302, and/or user. For example, in some implementations the calibration captures geometric, functional, positional, orientational, acceleration, inertial, and/or other properties of the live training device 302 or object, input device, and/or a user operator are captured and applied to the simulation, e.g., in order to more accurately represent the live training device 302 and/or user in the simulation. It is noted that the order of events described in FIG. 4 is exemplary. The steps can be performed in any suitable order, and/or in any suitable parallel and/or overlapping time, in other implementations.

In step 402, device 200 enters a calibration mode. In some implementations, calibration mode is entered in response to initiation by the user. In some implementations, calibration mode is entered in response to the interface device 200 being turned on or reset. In some implementations, calibration mode is entered in response to the interface device 200 being connected to the simulation server 212. In some implementations, calibration mode is entered at a specific time after interface device 200 is turned on. In some implementations, calibration mode is entered after the elapse of a time interval, e.g., at a certain time after interface device 200 is turned on or at regular repeating intervals. In some implementations, calibration mode is entered in response to a trigger condition being met, such as detection of calibration drifting out of nominal parameters, or resetting the interface device 200 or simulation server 212. Any desired condition or action may be used to initiate the calibration mode in various implementations. During the calibration mode, in step 404, device 202 captures calibration information, such as orientation, position, inertial, geometric, and/or any other suitable information regarding input device 204, live training device 302, the user, and/or any other suitable physical and/or environmental information, e.g., as discussed above. In some implementations, the live training device 302 is identifiable based on the physical information. For example, in some implementations, device 202, simulation server 212, or another device in communication with device 202 identifies live training device 302 as a particular type of equipment, a particular item of equipment, or otherwise, based on the physical information. In some implementations, simulation server 212 modifies a simulation based on the identification of live training device 302 and/or the physical information.

In some implementations, the calibration information is entered by a user via keyboard or any other suitable interface, is loaded from a configuration file from any suitable source, and/or is captured by measurement device 208, e.g., during manipulation or movement of input device 204 and/or a live training device 302 attached to input device 204, and/or a user operating the live training device 302 and/or input device 204.

On condition 406 that the calibration is complete, the calibration information is stored in step 408. Otherwise, calibration continues until complete.

In some implementations, the calibration information is stored in memory 214, on simulation server 212, or in any other suitable memory and/or storage location in communication with device 200.

In some implementations, calibration is complete when indicated by the user, e.g., via input device 204 or otherwise. In some implementations, calibration is complete when a threshold amount or type of information has been captured. In some embodiments, calibration mode is complete in response to a simulation beginning. In some implementations, calibration mode is complete in response to the interface device 200 being connected to the simulation server 212. In some implementations, calibration mode is complete at a specific time after interface device 200 is turned on. In some implementations, calibration mode is complete after the elapse of a time interval, e.g., at a certain time after interface device 200 is turned on or at regular repeating intervals. In some implementations, calibration mode is complete in response to a trigger condition being met, such as detection of calibration within nominal parameters. Any desired condition or action may be used to complete the calibration mode in various implementations.

It is noted that the order of events described in FIG. 4 is exemplary. The steps can be performed in any suitable order, and/or in any suitable parallel and/or overlapping time, in other implementations. In some implementations, steps may be omitted or added.

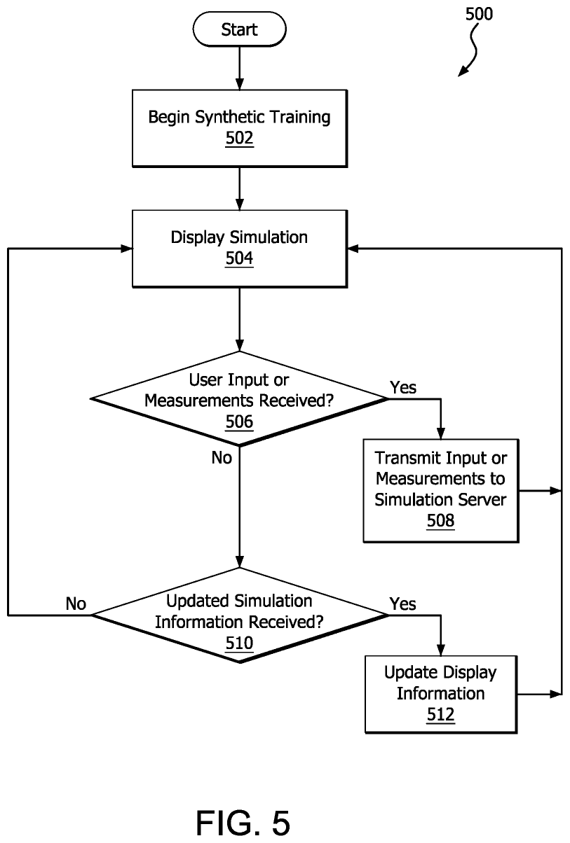

FIG. 5 is a flow chart illustrating example operation of the interface device described with respect to FIGS. 2, 3, and 4.

In step 502, synthetic training begins. In some implementations, synthetic training is begun in response to the interface device 200 being turned on or reset. In some implementations, synthetic training is begun in response to the interface device 200 being connected to the simulation server 212. In some implementations, synthetic training is begun at a specific time after interface device 200 is turned on. In some implementations, synthetic training is begun after the elapse of a time interval, e.g., at a certain time after interface device 200 is turned on. In some implementations, synthetic training is begun in response to a trigger condition being met, such as a user selection, e.g., by a button or other control, or by resetting the interface device 200 or simulation server 212. In some implementations, synthetic training is begun in response to the simulation server 212 being turned on or reset, or in response to a signal from simulation server 212. Any desired condition or action may be used to initiate synthetic training in various implementations. During synthetic training, a simulation is displayed to the user in step 504. On condition 506 that user input and/or measurements (e.g., as described above) are received by device 202 (e.g., via input device 204 and/or measurement device 208), the input and/or measurements are transmitted to the simulation server 212 (e.g., via communications interface 210) in step 508. In some implementations, the input and/or measurements are modified based on the calibration information described above. In some implementations, movements of the live training device 302 are mapped to a simulation running on simulation server 212 based on the calibration information. In some implementations, aspects of the live training device 302 are mapped to a model of the live training device 302 within the simulation running on simulation server 212 based on the calibration information. In some implementations, aspects of the simulation (e.g., slew rates) running on simulation server 212 are adjusted based on the configuration information.

On condition 510 that updated simulation information is received (e.g., from simulation server 212 via communications interface 210), the display information is updated in step 512.

It is noted that the order of events described in FIG. 5 is exemplary. The steps can be performed in any suitable order, and/or in any suitable parallel and/or overlapping time, in other implementations. In some implementations, steps may be omitted or added.

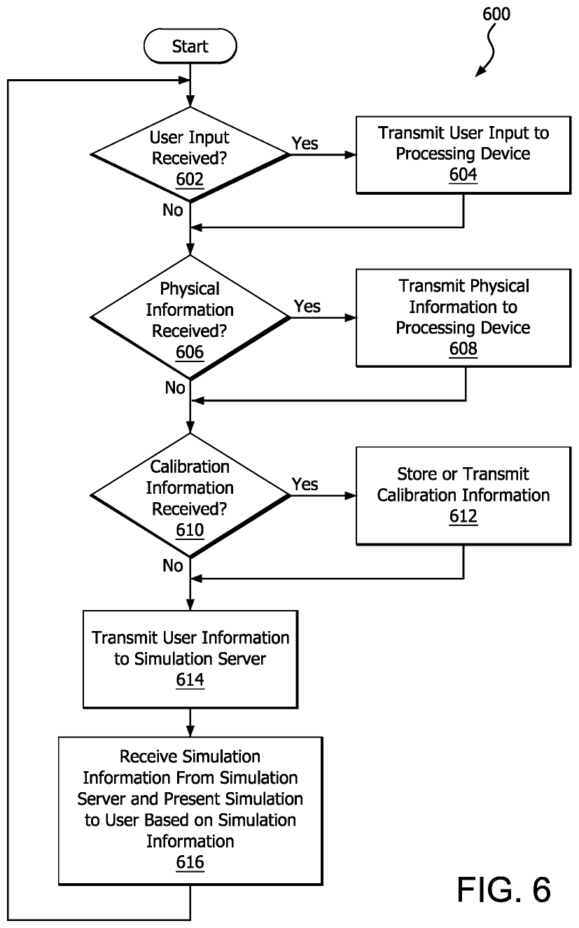

FIG. 6 is a flow chart illustrating example operation of the interface device described with respect to FIGS. 2-5.

On condition 602, that user input is received (e.g., via the input device 204, e.g., based on user actuation of a live training object), the user input is transmitted to a processing device (e.g., processing device 202) in step 604.

On condition 606 that physical information is received (e.g., via the measurement device 208, e.g., based on movement of the live training object), the physical input is transmitted to the processing device in step 608.

On condition 610 that calibration information is received, the calibration information is stored in a memory (e.g., memory 214) or transmitted to the simulation server (e.g., simulation server 212) in step 612.

User information (e.g., based on the user input, based on the physical information, and/or based on the calibration information) is transmitted to the simulation server in step 614, and simulation information (e.g., based on the user information) is received from the simulation server and presented to the user in step 616 (e.g., via output device 206).

It is noted that the order of events described in FIG. 6 is exemplary. The steps can be performed in any suitable order, and/or in any suitable parallel and/or overlapping time, in other implementations. In some implementations, steps may be omitted or added.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a graphics processor, a machine learning processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory, magnetic media such as internal hard disks and removable disks, magneto-optical media, and optical media such as CD-ROM disks, and digital versatile disks (DVDs).

What is claimed is:

1. A synthetic training system, comprising:
a processing device;
a memory device;
an input interface configured to receive user input based on user actuation of a live training object and to transmit the user input to the processing device;
a measurement device physically coupled to the live training object and configured to measure physical information of the live training object and to transmit the physical information to the processing device;
the processing device configured to capture calibration information via the measurement device or the input interface or to input the calibration information from a configuration file and to store the calibration information in the memory device or to transmit the calibration information to a simulation server;
a communications interface configured to transmit user information to the simulation server and to receive simulation information from the simulation server, the user information based on the user input, based on the physical information, and based on the calibration information, and the simulation information based on the user input, based on the physical information, and based on the calibration information; and
an output device configured to present a simulation to the user, wherein the simulation is based on the simulation information.

2. The system of claim 1, wherein the processing device is configured to modify the user input based on the calibration information.

3. The system of claim 1, wherein the input interface comprises a button, pressure sensor, angle sensor, or switch.

4. The system of claim 1, wherein the measurement device comprises a position sensor, level sensor, or accelerometer.

5. The system of claim 1, wherein the live training object comprises a piece of equipment or a surrogate for the piece of equipment.

6. The system of claim 1, wherein the live training object comprises a infrared zoom laser illuminator designator (IZLID), laser rangefinder, or lightweight laser designator rangefinder (LLDR).

7. The system of claim 1, wherein the physical information comprises orientation, position, inertial, and/or geometric information regarding the live training object, the user, and/or a training environment.

8. The system of claim 1, wherein the communications interface comprises a universal serial bus (USB), Bluetooth connection, or WiFi connection.

9. The system of claim 1, wherein the output device comprises a display, projector, haptic inter-face, and/or virtual reality headset.

10. The system of claim 1, wherein the simulation comprises a virtual battlespace simulation (VBS).

11. A method for synthetic training, the method comprising:
receiving user input based on user actuation of a live training object and transmitting the user input to a processing device;
measuring physical information of the live training object and transmitting the physical information to the processing device;
capturing calibration information or inputting the calibration information from a configuration file, and storing the calibration information in a memory device or transmitting the calibration information to a simulation server via a communications interface;
transmitting user information to the simulation server and receiving simulation information from the simulation server, the user information based on the user input, based on the physical information, and based on the calibration information, and the simulation information based on the user input, based on the physical information, and based on the calibration information; and
presenting a simulation to the user, wherein the simulation is based on the simulation information.

12. The method of claim 11, further comprising modifying the user input based on the calibration information.

13. The method of claim 11, wherein the user input is received via a input interface which comprises a button, pressure sensor, angle sensor, or switch.

14. The method of claim 11, wherein the physical information is received via a measurement device that is physically coupled to the live training object and which comprises a position sensor, level sensor, or accelerometer.

15. The method of claim 11, wherein the live training object comprises a piece of equipment or a surrogate for the piece of equipment.

16. The method of claim 11, wherein the live training object comprises an infrared zoom laser illuminator designator (IZLID), laser rangefinder, or lightweight laser designator rangefinder (LLDR).

17. The method of claim 11, wherein the calibration information comprises orientation, position, inertial, and/or geometric information regarding the live training object, the user, and/or a training environment.

18. The method of claim 11, wherein user information is transmitted to the simulation server via the communications interface, and the simulation information is received via the communications interface, wherein the communications interface comprises a universal serial bus (USB), Bluetooth connection, or WiFi connection.

19. The method of claim 11, wherein the simulation is presented to the user on an output device which comprises a display, projector, haptic interface, and/or virtual reality headset.

20. The method of claim 11, wherein the simulation comprises a virtual battlespace simulation (VBS).
